(19) United States
(12) Patent Application Publication
(10) Pub. No.: US 2026/0204025 A1
(43) Pub. Date: Jul. 16, 2026

(54) INTERACTIVE INTELLIGENT DISTRIBUTED DIGITAL TWIN SYSTEMS

(71) Applicant: HITACHI, Ltd., Tokyo (JP)

(72) Inventors: Joseph OH, Ann Arbor, MI (US); Jie HU, Northville, MI (US)

(21) Appl. No.: 19/025,709

(22) Filed: Jan. 16, 2025

(51) Int. Cl. G06T 19/00

(52) U.S. Cl. CPC G06T 19/00

(57) ABSTRACT

A distributed digital twin controlling method that comprises receiving, by a processor, data associated with a physical asset in operation; extracting and preprocessing, by the processor, the data to generate fused data; performing, by the processor, fluctuation detection on the fused data to detect occurrence of an event; and for the event being detected, performing: determining, by the processor, existence of a virtual model for controlling a predetermined process operated by the physical asset; and for the virtual model being determined as existing, performing model update on the virtual model using the fused data to generate an updated virtual model, and controlling the physical asset based on an output of the updated virtual model.

### BACKGROUND

### Field

The present disclosure is generally directed to a method and a system for performing distributed digital twin control

### Related Art

In the realm of Industry 4.0 and smart manufacturing, there is a heightened focus on promptly addressing fluctuations or unforeseen events within manufacturing facilities. Digital Twin technology emerges as a crucial solution to these challenges. A digital twin serves as a virtual duplicate of a physical system, and is continually updated through data collected from the physical counterpart. These digital replicas are engineered to simulate, monitor, and optimize physical systems

Industry examples of digital twin solutions include MICROSOFT AZURE DIGITAL TWIN, a cloud-based service capable of modeling buildings, factories, and railways, and SIEMENS DIGITAL TWIN, which offers multi-physics simulations, data analytics, and machine learning for data processing and analysis. Anticipated benefits of employing digital twins encompass expedited decision-making from product design to operations, enhanced operational efficiency, reduction of heuristic planning processes, decreased costs and downtime, and improved asset lifecycle management

In the related art, a method of identifying objects and generating warnings through a digital twin environment is disclosed. Specifically, uncertain/unknown physical objects entering a production line are identified and warnings are generated through object identification through digital twin utilization. The related art assumes that comprehensive digital twin systems must encompass all corresponding physical asset sub-systems. However, frameworks based on full asset coverage may encounter barriers at the outset of digital twin development due to their high initial investment costs and operational downtime

While there is a growing need for digital twin technology in manufacturing, its full implementation faces obstacles, primarily stemming from the substantial computational resources required for computing, visualizing, and communicating between physical and virtual assets. There exists a need for a flexible digital twin control system that is capable of efficiently connecting physical and virtual assets across various developmental stages

### SUMMARY

The concept of a distributed digital twin control system revolves around managing data communication between physical and virtual assets by leveraging detected events from the physical assets. Example implementations intelligently identify specific physical assets requiring updates, thus minimizing unnecessary data communication and updates to virtual models. Consequently, this reduces the size and capacity requirements of computing and communication devices, along with the associated investment costs

Aspects of the present disclosure involve an innovative method for performing distributed digital twin control. The method may include receiving, by a processor, data associated with a physical asset in operation; extracting and preprocessing, by the processor, the data to generate fused data; determining, by the processor, existence of a virtual model for controlling a predetermined process operated by the physical asset; for the virtual model being determined as existing, performing, by the processor, fluctuation detection on the fused data to detect occurrence of an event; and for the event being detected, performing, by the processor, model update on the virtual model using the fused data to generate an updated virtual model, and controlling the physical asset based on an output of the updated virtual model

Aspects of the present disclosure involve an innovative non-transitory computer readable medium, storing instructions for performing distributed digital twin control. The instructions may include receiving data associated with a physical asset in operation; extracting and preprocessing the data to generate fused data; determining existence of a virtual model for controlling a predetermined process operated by the physical asset; for the virtual model being determined as existing, performing fluctuation detection on the fused data to detect occurrence of an event; and for the event being detected, performing model update on the virtual model using the fused data to generate an updated virtual model, and controlling the physical asset based on an output of the updated virtual model

Aspects of the present disclosure involve an innovative server system for performing distributed digital twin control. The server system may include a memory; and a processor in communication with the memory. The processor is configured to receive data associated with a physical asset in operation; extract and preprocess the data to generate fused data; determine existence of a virtual model stored in the memory for controlling a predetermined process operated by the physical asset; for the virtual model being determined as existing, perform fluctuation detection on the fused data to detect occurrence of an event; and for the event being detected, perform model update on the virtual model using the fused data to generate an updated virtual model, and control the physical asset based on an output of the updated virtual model

Aspects of the present disclosure involve an innovative method for performing distributed digital twin control. The method may include receiving, by a processor, user input from a user for controlling a physical asset; receiving, by the processor, data associated with the physical asset in operation; generating, by the processor, fused data from the data based on the user input; identifying, by the processor, a physical asset sub-system of the physical asset based on the fused data; determining, by the processor, whether a constraint exists in the user input; and for the constraint being determined as existing, reconfiguring, by the processor, a first virtual model that corresponds to the physical asset sub-system based on the constraint to generate a second virtual model

Aspects of the present disclosure involve an innovative non-transitory computer readable medium, storing instructions for performing distributed digital twin control. The instructions may include receiving user input from a user for controlling a physical asset; receiving data associated with the physical asset in operation; generating fused data from the data based on the user input; identifying a physical asset sub-system of the physical asset based on the fused data; determining whether a constraint exists in the user input; and for the constraint being determined as existing, reconfiguring a first virtual model that corresponds to the physical asset sub-system based on the constraint to generate a second virtual model

Aspects of the present disclosure involve an innovative server system for performing distributed digital twin control. The server system may include a memory; and a processor in communication with the memory. The processor is configured to receive user input from a user for controlling a physical asset; receive data associated with the physical asset in operation; generate fused data from the data based on the user input; identify a physical asset sub-system of the physical asset based on the fused data; determine whether a constraint exists in the user input; and for the constraint being determined as existing, reconfigure a first virtual model stored in the memory that corresponds to the physical asset sub-system based on the constraint to generate a second virtual model

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements

FIG. 1 illustrates an example system configuration diagram of distributed digital twin control system 100, in accordance with an example implementation

FIG. 2 illustrates an example process flow 200 of the distributed digital twin control system 100, in accordance with an example implementation

FIG. 3 illustrates an example system configuration diagram of distributed digital twin control system 300, in accordance with an example implementation

FIG. 4 illustrates an example process flow 400 of the distributed digital twin control system 300, in accordance with an example implementation

FIG. 5 illustrates an example computing environment with an example computer device suitable for use in some example implementations

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations

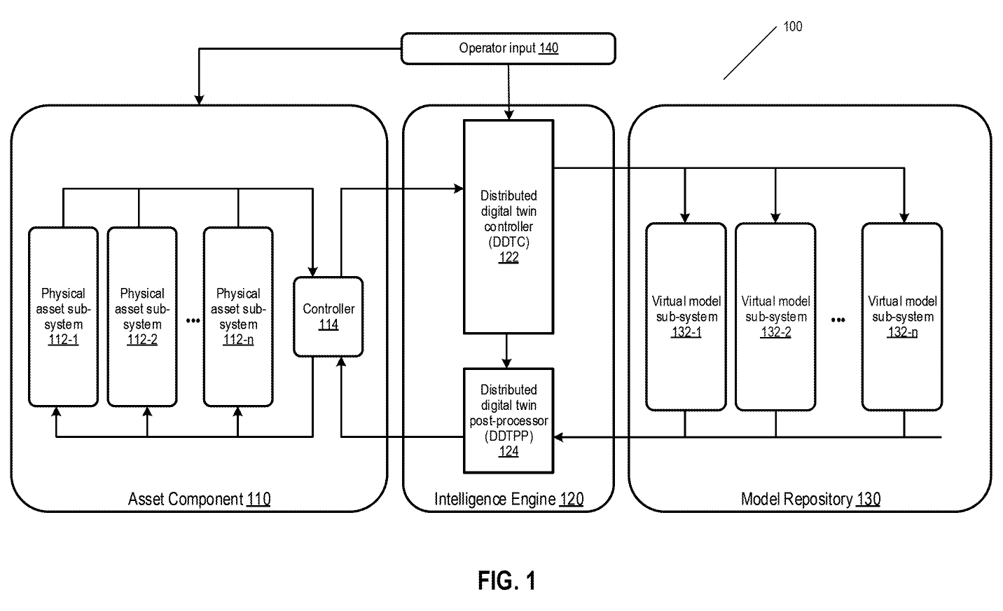

FIG. 1 illustrates an example system configuration diagram of distributed digital twin control system 100, in accordance with an example implementation. As illustrated in FIG. 1, the distributed digital twin control system 100 may include components such as, but not limited to, an asset component 110, an intelligence engine 120, a model repository 130, etc. The asset component 110 may include one or more physical asset sub-systems (e.g. physical asset sub-systems 112-1 to 112-n, etc.) The asset component 110 may be any combination of one or more assets such as, but not limited to, robots, machines, conveyors, automated guided vehicles (AGVs), etc

In some example implementations, the asset component 110 may also include a measurement system for measuring/detecting environmental conditions, such as room temperature, air quality, etc. The measurements may then be provided as additional input to the intelligence engine 120 for further processing. The asset component 110 can be updated in various ways using the intelligence engine 120. In some example implementations, updates on the asset component 110 can be performed through programmable logic controllers, AGVs, manual input by human operators, etc

The controller 114 is a component of the asset component 110, and is utilized to control the physical asset sub-systems 112-1 to 112-n. The physical asset sub-systems 112-1 to 112-n may be one or more, or any combination of devices such as, but not limited to, a robot, a machine, a conveyor, an industrial machinery/device, a monitoring device, etc. The controller 114 receives sensor data/operating data from the physical asset sub-systems 112-1 to 112-n (e.g., through sensors residing on the various physical asset subsystems), and communicates with a distributed digital twin controller (DDTC) 122 and a distributed digital twin post-processor (DDTPP) 124 of the intelligence engine 120, which will be described in more detail below

The intelligence engine 120 controls data flow between the asset component 110 and various virtual models that are stored in the model repository 130. The intelligence engine 120 may include components such as, but not limited to, the DDTC 122, the DDTPP 124, etc. The DDTC 122 of the intelligence engine 120 intelligently determines data flow between the intelligence engine 120 and the model repository 130. Specifically, the DDTC 122 obtains data from the asset component 110, and extracts and pre-processes the obtained data in a form that can be used directly by the virtual models contained in the model repository 130. In some example implementations, the intelligence engine 120 resides on a first server and the model repository 130 resides on a second server. In alternate implementations, both the intelligence engine 120 and the model repository 130 reside on the same server or operate from a single system hardware (e.g., computer

The data received from the asset component 110 may include data such as, but not limited to, hard data (e.g., data acquisition (DAQ) measurement, operation data, etc.), soft data (e.g., expert knowledge, human operation data, audio, vision, human recognition, etc.), etc. In some example implementations, data such as operator input 140, which is received by the asset component 110 to control one or more physical asset sub-systems 112-1 to 112-n, is also received by the DDTC 122 as part of status monitoring and feedback review. The received data may be fused and stored as knowledge graph(s) and system status monitoring data. For example, a lidar sensor measurement of AGV may be combined with a human operator’s perception and expert knowledge to generate fused data. Those two different types of data can be fused together to capture reality with higher accuracy, which may be used to generate solutions that are highly efficient/effective

The DDTC 122 may detect any event or occurrence of an event associated with the physical assets in the asset component 110 with a fluctuation detection algorithm. The algorithm utilizes the fused data to determine active/dynamic portion of the system and determines whether to update the corresponding subsystem virtual models (e.g., virtual model sub-systems 132-1 to 132-n). Data corresponding to the active/dynamic portion of the system is then fed to the corresponding subsystem virtual models (e.g., virtual model sub-systems 132-1 to 132-n) in the model repository 130 with minimum data traffic. Each of the virtual model sub-systems 132-1 to 132-n operates a predefined process to be performed by a physical asset sub-system of the asset component 110 and reflects history of the operation

In a situation where a virtual model/virtual model sub-system that corresponds to a physical asset subsystem is absent in the model repository 130, an alternative virtual model/virtual model sub-system may be utilized as a direct function of the measured data to provide operational boundary information/operational thresholds in the DDTC 122

The virtual model sub-systems 132-1 to 132-n run in a respective computing resource. The virtual models/virtual model sub-systems 132-1 to 132-n provide unmeasured/simulated data by using dynamic data flow as input to a simulation model. In some example implementations, one or more of the virtual model sub-systems 132-1 to 132-n may provide simulations related to operations/or control of other virtual model sub-system(s). Such related simulations may include human operation simulations, energy consumption estimation simulations, etc. The simulation model generates Design of Experiments (DOE) simulation results for operation optimization. For example, conveyor speed can be adjusted due to predicted operation capability in the case where an unexpected event happens to one of the manufacturing robots

In some example implementations, the physics based digital twin generated information/simulated result is relayed to the DDTPP 124 to establish near real-time/operating boundary information to update the knowledge graph(s) and the system status monitoring data. In alternate example implementations, the one or more virtual model sub-systems 132-1 to 132-n may be retrieved by the intelligence engine 120 for performing further processing simulations by the DDTPP 124 to establish near real-time/operating boundary information to update the knowledge graph(s) and the system status monitoring data. The updated knowledge graph(s) and the system status monitoring data may then be transmitted from the DDTPP 124 to the asset component 110 to further control and address the abnormalities associated with the physical asset sub-systems 112-1 to 112-n

The controller 114 then receives feedback data from the physical asset sub-systems 112-1 to 112-n (e.g., through sensors residing on the various physical asset subsystems), and transmits the feedback data to the DDTC 122 of the intelligence engine 120, for further monitoring and updating of the virtual models

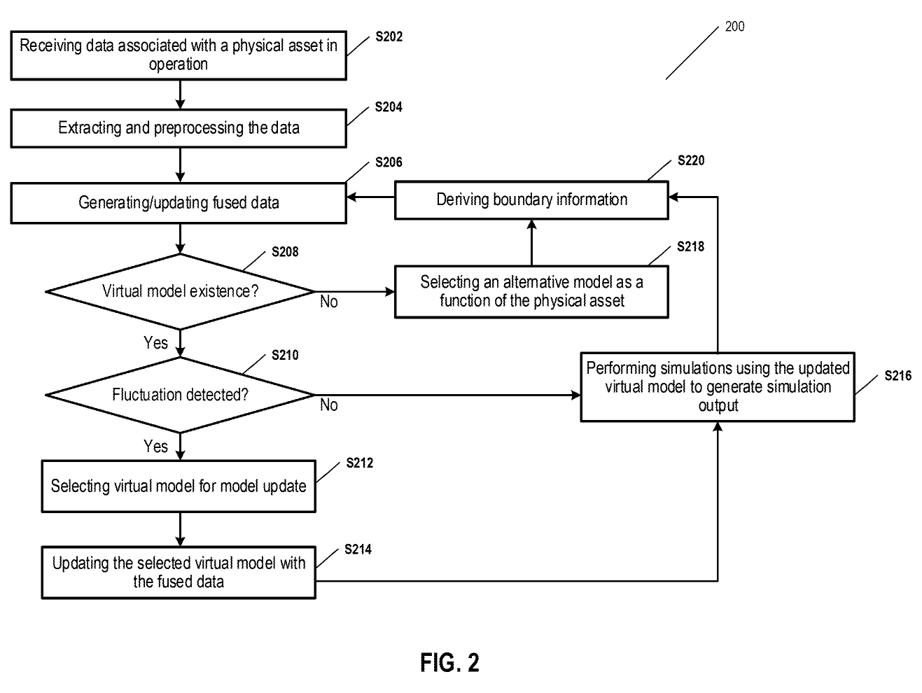

FIG. 2 illustrates an example process flow 200 of the distributed digital twin control system 100, in accordance with an example implementation. The process begins at step S202 where data associated with a physical asset in operation is received. The data comprises raw data of the physical asset and qualitative data associated with the physical asset. Such data may include, but not limited to, hard data (e.g., DAQ measurement, operation data, etc.) and soft data (e.g., expert knowledge, human operation data, audio, vision, human recognition, etc.) associated with the physical asset sub-systems 112-1 to 112-n. At step S204, the received data is extracted and preprocessed. At step S206, fused data is generated from extracted and preprocessed data. The fused data may include information such as, but not limited to, a knowledge graph, system monitoring data/information, etc

At step S208, a determination is made as to whether virtual model(s) for controlling a predetermined process operated by the physical asset (the one or more physical asset sub-systems 112-1 to 112-n) exists. The virtual model is a digital twin of the physical asset. For the virtual model(s) being determined as existing at step S208, the process then continues to step S210 to determine whether fluctuation or an event has occurred for any of the virtual model sub-systems based on the fused data (e.g., detected abnormality, receiving sensor value from a physical asset subsystem that exceeds operating boundary of the physical asset subsystem, etc

For the event/fluctuation being detected at step S210, the process then continues to step S212 where a virtual model is selected for model update based on the detected event/fluctuation. For example, if detected event/fluctuation occurred at physical asset subsystems 112-2, then a corresponding virtual model (e.g., virtual model sub-system 132-2) is selected for update. The process then continues to perform model update on the virtual model using the fused data to generate an updated virtual model in real-time at step S214. At step S216, simulations are performed using the updated virtual model to generate simulation output

In alternate example implementations, other simulations may be performed in conjunction with the updated virtual model to generate simulation output at step S216. Specifically, one or more of the virtual model sub-systems 132-1 to 132-n other than the updated virtual sub-system may provide simulations related to operations/or control of the updated virtual model sub-system. Such related simulations may include human operation simulations, energy consumption estimation simulations, etc., where results may used as input to the updated virtual model sub-system

At step S220, operating boundary information for the physical asset is derived from the simulation output. Following step S220, the process then returns to step S206 where the fused data comprising the knowledge graph and system monitoring data/information is updated using the operating boundary information to monitor and control the physical asset

For the virtual model(s) being determined as non-existing at step S208, the process then continues to step S218 to select an alternative model as a function of the physical asset. For example, in a physical asset subsystem does not have an existing corresponding virtual model, then a closest matching virtual model (alternative model) is selected as a function of the physical asset subsystem. At step S220, operating boundary information for monitoring and controlling the physical asset are then generated using the alternative model. The process then continues to step S206 where the knowledge graph and the system monitoring data are updated using the operating boundary information

For the event not being detected/fluctuation not being detected at step S210, the process proceeds to step S216 where simulations are performed using the virtual model to generate simulation output. Steps S202-S220 are performed iteratively as feedback is received

The foregoing example implementation may have various benefits and advantages. For example, an innovative method for controlling distributed digital twin that selectively updates only a subset of assets. Example implementations offer a flexible and adaptable operating solution with reduced initial investment requirements. Additionally, the distributed nature of digital twin systems enables progressive development and application throughout various developmental stages

In a second embodiment, an Artificial Intelligence (AI) agent/model that receives human operator input to perform virtual model update is incorporated. Specifically, the AI agent/model receives human operator input in natural language (e.g., via a text prompt, voice input, etc.), and translates the received input into a simulation language to perform virtual model updates/reconfigurations

For example, a virtual model may be outdated due to unexpected changes in the manufacturing facility that cannot be easily defined by existing source of measurement. Then, a human operator communicates with an AI agent/model in a natural language via a prompt to provide the obtained knowledge of the changes. The AI agent/model then translates the information in a natural language into a simulation language to update or reconfigure the corresponding virtual models according to the changes

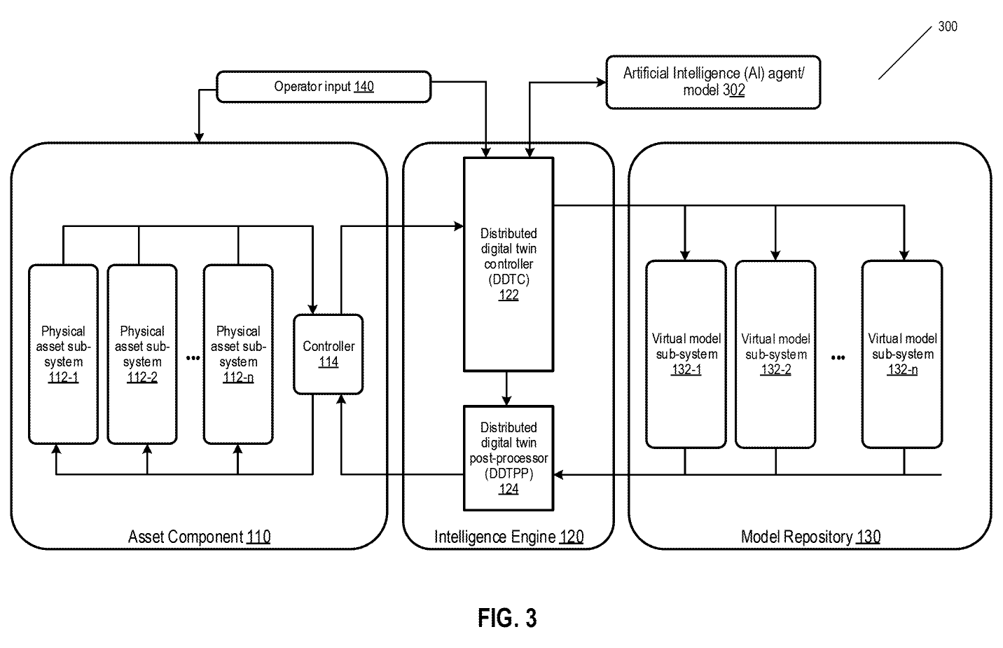

FIG. 3 illustrates an example system configuration diagram of distributed digital twin control system 300, in accordance with an example implementation. As illustrated in FIG. 3, the distributed digital twin control system 300 may include components such as, but not limited to, an asset component 110, an intelligence engine 120, a model repository 130, etc., which are identical to the same components as illustrated in FIG. 1. Unlike FIG. 1, the distributed digital twin control system 300 further include an Artificial Intelligence (AI) agent/model 302, which will be described in more detail below

The asset component 110 may include one or more physical asset sub-systems (e.g. physical asset sub-systems 112-1 to 112-n, etc.) The asset component 110 may be any combination of one or more assets such as, but not limited to, robots, machines, conveyors, automated guided vehicles (AGVs), etc. In some example implementations, the asset component 110 may include a measurement system for measuring/detecting environmental conditions, such as room temperature, air quality, etc. The measurements may then be provided as additional input to the intelligence engine 120 for further processing

0042]The asset component 110 can be updated in various ways using the intelligence engine 120. In some example implementations, additional updates on the asset component 110 can be performed through programmable logic controllers, AGVs, manual input by human operators, etc

The controller 114 is a component of the asset component 110, and is utilized to control the physical asset sub-systems 112-1 to 112-n. The physical asset sub-systems 112-1 to 112-n may be one or more, or any combination of devices such as, but not limited to, a robot, a machine, a conveyor, an industrial machinery/device, a monitoring device, etc. The controller 114 receives sensor data/operating data from the physical asset sub-systems 112-1 to 112-n (e.g., through sensors residing on the various physical asset subsystems), and communicates with a distributed digital twin controller (DDTC) 122 and a distributed digital twin post-processor (DDTPP) 124 of the intelligence engine 120, which will be described in more detail below

The intelligence engine 120 controls data flow between the asset component 110 and various virtual models that are stored in the model repository 130. The intelligence engine 120 may include components such as, but not limited to, the DDTC 122, the DDTPP 124, etc. The DDTC 122 of the intelligence engine 120 intelligently determines data flow between the intelligence engine 120 and the model repository 130. Specifically, the DDTC 122 obtains data from the asset component 110, and extracts and pre-processes the obtained data in a form that can be used directly by the virtual models contained in the model repository 130. In some example implementations, the intelligence engine 120 resides on a first server and the model repository 130 resides on a second server. In alternate implementations, both the intelligence engine 120 and the model repository 130 reside on the same server or operate from a single system hardware (e.g., computer

The data received from the asset component 110 may include data such as, but not limited to, hard data (e.g., data acquisition (DAQ) measurement, operation data, etc.), soft data (e.g., expert knowledge, human operation data, audio, vision, human recognition, etc.), etc. In some example implementations, data such as operator input 140, which is received by the asset component 110 to control one or more physical asset sub-systems 112-1 to 112-n, is also received by the DDTC 122 as part of status monitoring and feedback review. The received data may be fused and stored as knowledge graph(s) and system status monitoring data. For example, a lidar sensor measurement of AGV may be combined with a human operator’s perception and expert knowledge to generate fused data. Those two different types of data can be fused together to capture reality with higher accuracy, which may be used to generate solutions that are highly efficient/effective

The AI agent/model 302 provides a direct and intuitive interaction between the users and the DDTC 122. Users interact with the AI agent/model 302 through prompts, which are expressions in natural language. The prompts could be one or more queries directed to system status, requests to change the system configurations, etc. The prompts are then translated into software functions that can be processed by a processor or a computing device

Training of the AI agent/model 302 may be performed using historical data and previously generated virtual models. The AI agent/model 302 may include, but not limited to, a convolutional neural network (CNN), a recurrent neural network (RNN), a deep RNN (DRNN), a Q-learning network (QN), a deep Q-learning network (DQN), decision trees, a K-Nearest Neighbors, etc. RNN may include long short-term memory (LSTM), large language model (LLM), etc

Data (e.g., hard data, soft data, etc.) received from the various sources (e.g., asset component 110, operator input 140, etc.) are then fused based on the translated prompts generated by the AI agent/model 302 using the DDTC 122. The affected physical asset sub-systems are identified and selected for further processing by the DDTC 122. If additional constraints are added based on user’s request/input to the AI agent/model 302, the corresponding virtual models/sub-systems as stored in the model repository 130 will be reconfigured based on the updated constraints, resulting in AI-generated virtual model sub-system(s). For example, if virtual model sub-system 130-1 is selected for update, then an AI-generated virtual model, such as virtual model sub-system 130-2 may be created and stored in the model repository 130

In some example implementations, as part of the user quest, a simulation request may be made to request simulation(s) to be conducted using the AI-generated virtual models. Simulation(s) may be performed at one or more of the intelligence engine 120 or model repository 130. Outcomes of the simulation(s) will then be compiled into a simulation report/summary at the DDTC 122. The report may include information such as, but not limited to, the performance of the reconfigured system under the new constraints, expected maintenance and frequency under the new constraints, any information as requested by the user based on user input, etc

If a simulation is not requested by the user as part of the user quest, the status of the sub-system will be extracted at DDTC 122 and transmitted in the form of a status report/summary to the user through the AI agent/model 302. The status report/summary may include information such as, but not limited to, the conditions of the machines, production statistics, etc

In some example implementations, the simulation report/summary report and the status report/summary are returned to the user through the AI agent/model 302 for review on a user device. In some example implementations, the simulation report/summary report and the status report/summary may be presented through a graphic display such as, but not limited to, plots, graphs/diagrams, etc

In some example implementations, the physics based digital twin generated information/simulated result is relayed to the DDTPP 124 to establish near real-time/operating boundary information to update the knowledge graph(s) and the system status monitoring data. In alternate example implementations, the one or more virtual model sub-systems 132-1 to 132-n may be retrieved by the intelligence engine 120 for performing further processing simulations by the DDTPP 124 to establish near real-time/operating boundary information to update the knowledge graph(s) and the system status monitoring data. The updated knowledge graph(s) and the system status monitoring data may then be transmitted from the DDTPP 124 to the asset component 110 to further control and address the abnormalities associated with the physical asset sub-systems 112-1 to 112-n

The controller 114 then receives feedback data from the physical asset sub-systems 112-1 to 112-n (e.g., through sensors residing on the various physical asset subsystems), and transmits the feedback data to the DDTC 122 of the intelligence engine 120, for further monitoring and updating of the virtual models

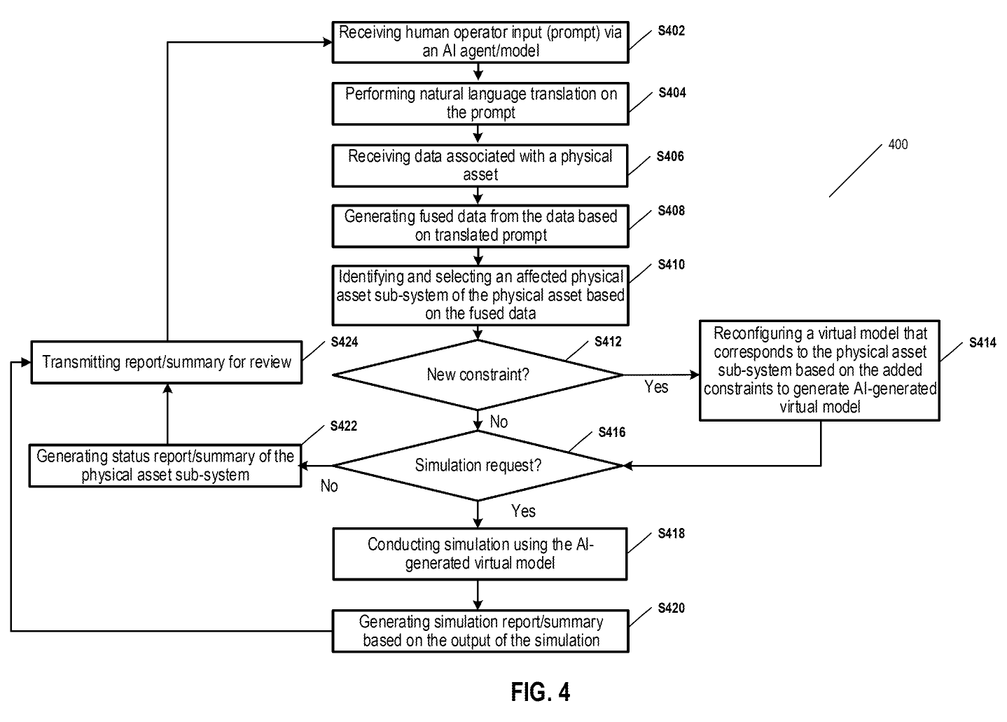

FIG. 4 illustrates an example process flow 400 of the distributed digital twin control system 300, in accordance with an example implementation. The process begins at step S402 where human operator input is received via the AI agent/model 302 in the form of a prompt. At step S404, natural language translation is performed on the prompt using the AI agent/model 302. At step S406, data associated with a physical asset in operation is received. The data comprises raw data of the physical asset and qualitative data associated with the physical asset. Such data may include, but not limited to, hard data (e.g., DAQ measurement, operation data, etc.) and soft data (e.g., expert knowledge, human operation data, audio, vision, human recognition, etc.) associated with the physical asset sub-systems 112-1 to 112-n. In some example implementations, the received data may be extracted and preprocessed. At step S408, fused data is generated from data based on the translated prompts generated by the AI agent/model 302. The fused data may include information such as, but not limited to, a knowledge graph, system monitoring data/information, etc

At step S410, the affected physical asset sub-system(s) is identified and selected according to the fused data. A determination is made as to whether one or more additional constraints exist based on the user request/input to the AI agent/model 302 at step S412. If the answer is yes at step S412, then the virtual model(s) that corresponds to the physical asset sub-system(s) will be reconfigured based on the added constraints, resulting in AI-generated virtual model sub-system(s) at step S414. If the answer is no at step S412 or step S414 has been completed, then process continues to step S416, where a determination is made as to whether the user request contains a simulation request

If the answer is yes at step S416, then the process continues to step S418 where simulation is performed/conducted using the AI-generated virtual model sub-system(s). At step S420, a simulation report/summary report is then generated based on the output of the simulation. After completion of step S420, the simulation report/summary report is then transmitted to the AI agent/model 302, to be reviewed by the user at step S424. If the answer is no at step S416, then the process continues to step S422 where a status summary/report is generated and transmitted to the AI agent/model 302, to be reviewed by the user at step S424. In some example implementations, steps S202-S220 of FIG. 2 can be performed after the AI-generated virtual model has been created. For example, if an abnormality/fluctuation is detected, the AI-generated virtual model may be identified and selected for further model update

The foregoing example implementation may have various benefits and advantages. For example, an innovative method for controlling distributed digital twin that selectively updates only a subset of assets based on user request via an AI agent/model. Through use of the AI agent/model, an AI-generated virtual model can be created that better suits user requirements. Example implementations offer a flexible and adaptable operating solution with reduced initial investment requirements. Additionally, the distributed nature of digital twin systems enables progressive development and application throughout various developmental stages

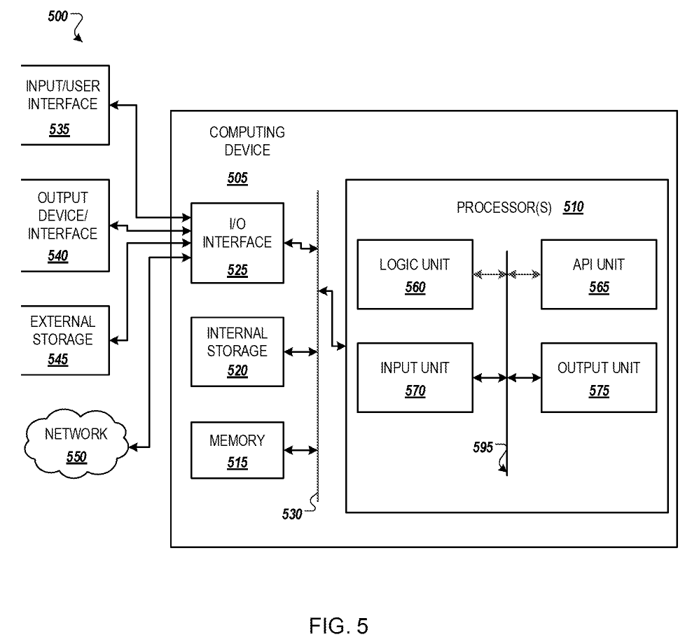

FIG. 5 illustrates an example computing environment with an example computer device suitable for use in some example implementations. Computer device 505 in computing environment 500 can include one or more processing units, cores, or processors 510, memory 515 (e.g., RAM, ROM, and/or the like), internal storage 520 (e.g., magnetic, optical, solid-state storage, and/or organic), and/or IO interface 525, any of which can be coupled on a communication mechanism or bus 530 for communicating information or embedded in the computer device 505. IO interface 525 is also configured to receive images from cameras or provide images to projectors or displays, depending on the desired implementation

Computer device 505 can be communicatively coupled to input/user interface 535 and output device/interface 540. Either one or both of the input/user interface 535 and output device/interface 540 can be a wired or wireless interface and can be detachable. Input/user interface 535 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 540 may include a display, television, monitor, printer, speaker, braille, or the like. In some example implementations, input/user interface 535 and output device/interface 540 can be embedded with or physically coupled to the computer device 505. In other example implementations, other computer devices may function as or provide the functions of input/user interface 535 and output device/interface 540 for a computer device 505

Examples of computer device 505 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like

Computer device 505 can be communicatively coupled (e.g., via IO interface 525) to external storage 545 and network 550 for communicating with any number of networked components, devices, and systems, including one or more computer devices of the same or different configuration. Computer device 505 or any connected computer device can be functioning as, providing services of, or referred to as a server, client, thin server, general machine, special-purpose machine, or another label

IO interface 525 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 500. Network 550 can be any network or combination of networks (e.g., the Internet, local area network, wide area network, a telephonic network, a cellular network, satellite network, and the like

Computer device 505 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory

Computer device 505 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others

Processor(s) 510 can execute under any operating system (OS) (not shown), in a native or virtual environment. One or more applications can be deployed that include logic unit 560, application programming interface (API) unit 565, input unit 570, output unit 575, and inter-unit communication mechanism 595 for the different units to communicate with each other, with the OS, and with other applications (not shown). The described units and elements can be varied in design, function, configuration, or implementation and are not limited to the descriptions provided. Processor(s) 510 can be in the form of hardware processors such as central processing units (CPUs) or in a combination of hardware and software units

In some example implementations, when information or an execution instruction is received by API unit 565, it may be communicated to one or more other units (e.g., logic unit 560, input unit 570, output unit 575). In some instances, logic unit 560 may be configured to control the information flow among the units and direct the services provided by API unit 565, the input unit 570, the output unit 575, in some example implementations described above. For example, the flow of one or more processes or implementations may be controlled by logic unit 560 alone or in conjunction with API unit 565. The input unit 570 may be configured to obtain input for the calculations described in the example implementations, and the output unit 575 may be configured to provide an output based on the calculations described in example implementations

Processor(s) 510 can be configured to receive data associated with a physical asset in operation as illustrated in FIGS. 1 and 2. The processor(s) 510 may also be configured to determine existence of a virtual model for controlling a predetermined process operated by the physical asset as illustrated in FIGS. 1 and 2. The processor(s) 510 may also be configured to, for the virtual model being determined as existing, perform fluctuation detection on the fused data to detect occurrence of an event as illustrated in FIGS. 1 and 2. The processor(s) 510 may also be configured to, for the event being detected, perform model update on the virtual model using the fused data to generate an updated virtual model, and control the physical asset based on an output of the updated virtual model as illustrated in FIGS. 1 and 2

The processor(s) 510 may also be configured to, for the event not being detected, control the physical asset based on an output of the virtual model as illustrated in FIGS. 1 and 2. The processor(s) 510 may also be configured to, for the event not being detected, control the physical asset based on an output of the virtual model as illustrated in FIGS. 1 and 2

The processor(s) 510 may also be configured to receive user input from a user for controlling a physical asset as illustrated in FIGS. 3 and 4. The processor(s) 510 may also be configured to receive data associated with the physical asset in operation as illustrated in FIGS. 3 and 4. The processor(s) 510 may also be configured to generate fused data from the data based on the user input as illustrated in FIGS. 3 and 4. The processor(s) 510 may also be configured to identify a physical asset sub-system of the physical asset based on the fused data as illustrated in FIGS. 3 and 4. The processor(s) 510 may also be configured to determine whether a constraint exists in the user input as illustrated in FIGS. 3 and 4. The processor(s) 510 may also be configured to, for the constraint being determined as existing, reconfigure a first virtual model that corresponds to the physical asset sub-system based on the constraint to generate a second virtual model as illustrated in FIGS. 3 and 4

The processor(s) 510 may also be configured to, for (i) the constraint being determined as not existing, or (ii) the second virtual model being generated, determine whether a simulation request exists in the user input as illustrated in FIGS. 3 and 4. The processor(s) 510 may also be configured to, for the simulation request being determined as existing, conduct a simulation using the second virtual model and generate a simulation report based on an output of the simulation as illustrated in FIGS. 3 and 4. The processor(s) 510 may also be configured to transmit the simulation report to the user for review as illustrated in FIGS. 3 and 4. The processor(s) 510 may also be configured to, for the simulation request being determined as not existing, generate a status report of the physical asset sub-system as illustrated in FIGS. 3 and 4. The processor(s) 510 may also be configured to transmitting the status report to the user for review as illustrated in FIGS. 3 and 4

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system’s registers and memories into other data similarly represented as physical quantities within the computer system’s memories or registers or other information storage, transmission or display devices

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims

What is claimed is:

1. A distributed digital twin controlling method, comprising:
receiving, by a processor, data associated with a physical asset in operation;
extracting and preprocessing, by the processor, the data to generate fused data;
determining, by the processor, existence of a virtual model for controlling a predetermined process operated by the physical asset;
for the virtual model being determined as existing, performing, by the processor, fluctuation detection on the fused data to detect occurrence of an event; and
for the event being detected, performing, by the processor, model update on the virtual model using the fused data to generate an updated virtual model, and controlling the physical asset based on an output of the updated virtual model.

2. The method of claim 1, wherein the virtual model is a digital twin of the physical asset,
wherein the performing the model update on the virtual model is performed in real-time.

3. The method of claim 1, further comprising:
for the event not being detected, controlling, by the processor, the physical asset based on an output of the virtual model.

4. The method of claim 3, wherein the data comprises raw data of the physical asset and qualitative data associated with the physical asset,
wherein the fused data comprises a knowledge graph and system monitoring data.

5. The method of claim 4, wherein the processor is configured to control the physical asset based on the output of the updated virtual model by:
performing simulations using the updated virtual model to generate simulation output; and
generating operating boundary information from the simulation output for monitoring and controlling the physical asset,
wherein the knowledge graph and the system monitoring data are updated using the operating boundary information.

6. The method of claim 4, further comprising:
for the virtual model being determined as non-existing, selecting an alternative model as a function of physical asset measurement for the physical asset; and
generating, using the alternative model, operating boundary information for monitoring and controlling the physical asset,
wherein the knowledge graph and the system monitoring data are updated using the operating boundary information.

7. The method of claim 1, further comprising:
for the event not being detected, controlling, by the processor, the physical asset based on an output of the virtual model,
wherein the processor is configured to control the physical asset based on the output of the virtual model by generating operating boundary information for monitoring and controlling the physical asset.

8. The method of claim 1, wherein the virtual model is associated with a physical asset sub-system from a plurality of physical asset sub-systems, and each one of the plurality of physical asset sub-systems performs a respective operation of the physical asset.

9. A distributed digital twin controlling system, comprising:
a physical asset in operation; and
a processor, wherein the processor is configured to:
receive data associated with the physical asset;
extract and preprocess the data to generate fused data;
determine existence of a virtual model for controlling a predetermined process operated by the physical asset;
for the virtual model being determined as existing, perform fluctuation detection on the fused data to detect occurrence of an event; and
for the event being detected, perform model update on the virtual model using the fused data to generate an updated virtual model, and control the physical asset based on an output of the updated virtual model.

10. The system of claim 9, wherein the virtual model is a digital twin of the physical asset,
wherein the performing the model update on the virtual model is performed in real-time.

11. The system of claim 9, wherein the processor is further configured to:
for the event not being detected, control, by the processor, the physical asset based on an output of the virtual model.

12. The system of claim 11, wherein the data comprises raw data of the physical asset and qualitative data associated with the physical asset,
wherein the fused data comprises a knowledge graph and system monitoring data.

13. The system of claim 12, wherein the processor is configured to control the physical asset based on the output of the updated virtual model by:
performing simulations using the updated virtual model to generate simulation output; and
generating operating boundary information from the simulation output for monitoring and controlling the physical asset,
wherein the knowledge graph and the system monitoring data are updated using the operating boundary information.

14. The system of claim 13, wherein the processor is further configured to:
for the virtual model being determined as non-existing, select an alternative model as a function of physical asset measurement for the physical asset; and
generate, using the alternative model, operating boundary information for monitoring and controlling the physical asset,
wherein the knowledge graph and the system monitoring data are updated using the operating boundary information.

15. The system of claim 9, further comprising:
for the event not being detected, controlling, by the processor, the physical asset based on an output of the virtual model,
wherein the processor is configured to control the physical asset based on the output of the virtual model by generating operating boundary information for monitoring and controlling the physical asset.

16. The system of claim 9, wherein the virtual model is associated with a physical asset sub-system from a plurality of physical asset sub-systems, and each one of the plurality of physical asset sub-systems performs a respective operation of the physical asset.

17. A distributed digital twin controlling method, comprising:
receiving, by a processor, user input from a user for controlling a physical asset;
receiving, by the processor, data associated with the physical asset in operation;
generating, by the processor, fused data from the data based on the user input;
identifying, by the processor, a physical asset sub-system of the physical asset based on the fused data;
determining, by the processor, whether a constraint exists in the user input; and
for the constraint being determined as existing, reconfiguring, by the processor, a first virtual model that corresponds to the physical asset sub-system based on the constraint to generate a second virtual model.

18. The method of claim 17, wherein the user input comprises a natural language translated prompt derived from a user prompt using an Artificial Intelligence model.

19. The method of claim 17, further comprising:
for (i) the constraint being determined as not existing, or (ii) the second virtual model being generated, determining, by the processor, whether a simulation request exists in the user input;
for the simulation request being determined as existing, conducting a simulation using the second virtual model and generating a simulation report based on an output of the simulation; and
transmitting the simulation report to the user for review.

20. The method of claim 19, further comprising:
for the simulation request being determined as not existing, generating a status report of the physical asset sub-system; and
transmitting the status report to the user for review.
